(19) United States
(12) Patent Application Publication
(10) Pub. No.: US 2010/0073707 A1
(43) Pub. Date: Mar. 25, 2010

(54) SYSTEMS AND METHODS FOR FACILITATING VIRTUAL CLOUD PRINTING

(75) Inventor: Andrew R. Ferlitsch, Camas, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/236,376

(22) Filed: Sep. 23, 2008

(51) Int. Cl. G06F 3/12

(52) U.S. Cl. 358/1.15

(57) ABSTRACT

A streaming printer that facilitates virtual cloud printing may include a network interface that receives engine-ready data from a cloud computing grid. The streaming printer may also include a raster input storage that temporarily holds the engine-ready data that is received via the network interface. The streaming printer may also include an engine cache storage that persistently holds the engine-ready data. The streaming printer may also include an output engine that outputs the engine-ready data.

### TECHNICAL FIELD

The present disclosure relates generally to printing devices and printing-related technology. More specifically, the present disclosure relates to systems and methods for facilitating virtual cloud printing.

### BACKGROUND

A printer is a peripheral device which produces a hard copy (i.e., permanent human-readable text and/or graphics) of documents stored in electronic form, usually on physical print media such as paper or transparencies. Printers are used with computers to print various kinds of items including letters, documents, pictures, etc.

Many different kinds of printers are commercially available. Printers may be classified by the underlying print technology they employ. Numerous such technologies have been developed over the years. For example, ink jet printers and laser printers are fairly common among computer users. Ink jet printers propel droplets of ink directly onto the paper. Laser printers use a laser beam to print.

Many printers are primarily used as local peripherals, and are attached by a printer cable or, in most new printers, a Universal Serial Bus (USB) cable to a computer which serves as a document source. Some printers, commonly known as network printers, have built-in network interfaces (typically wireless or Ethernet), and can serve as a hardcopy device for any user on the network. Individual printers are often designed to support both local and network-connected users at the same time. A few modern printers can directly interface to electronic media such as memory sticks or memory cards, or to image capture devices such as digital cameras, scanners, and electronic whiteboards.

Some printers are combined with a scanner and/or a fax machines in a single unit. Printers that include non-printing features are sometimes called Multi-Function Printers (MFP), Multi-Function Devices (MFD), or All-In-One (AIO) printers.

Benefits may be realized by improved systems and methods related to printing devices and printing-related technology.

### BRIEF DESCRIPTION OF THE DRAWINGS

FIG. 1 illustrates an exemplary operating environment in which the systems and methods disclosed herein may be utilized;

FIG. 2 illustrates a streaming printer;

FIG. 3 illustrates the streaming printer being operated from a cloud computing grid;

FIG. 4 illustrates the streaming printer receiving a command to download engine-ready data from the cloud computing grid;

FIG. 5 illustrates the streaming printer receiving a command to output the engine-ready data, where a single copy of a document is being printed;

FIG. 6 illustrates the streaming printer receiving a command to store the engine-ready data in persistent storage;

FIG. 7 illustrates the streaming printer receiving a command to output the engine-ready data, where multiple copies of a document are being printed;

FIG. 8 illustrates the streaming printer receiving a command to delete the engine-ready data;

FIG. 9 illustrates a method that may be implemented by a cloud computing grid in accordance with the present disclosure;

FIG. 10 illustrates a method that may be implemented by a streaming printer in accordance with the present disclosure; and

FIG. 11 illustrates certain components that may be included within a computing device.

### DETAILED DESCRIPTION

A streaming printer that facilitates virtual cloud printing is disclosed. The streaming printer may include a network interface that receives engine-ready data from a cloud computing grid. The streaming printer may also include a raster input storage that temporarily holds the engine-ready data that is received via the network interface. The streaming printer may also include an engine cache storage that persistently holds the engine-ready data. The streaming printer may also include an output engine that outputs the engine-ready data.

The streaming printer may not include a general purpose central processing unit (CPU). Alternatively, the streaming printer may include a very low-cost CPU. The streaming printer also may not include page description language (PDL) interpreters, embedded fonts, peripheral management firmware, or raster image processing (RIP) capability.

The streaming printer may also include an engine status unit that provides feedback on the operational status of the output engine. The streaming printer may also include an engine specification unit that provides information about operational characteristics of the streaming printer. The streaming printer may operate using a reduced command set that consists of a data command, a persist command, an output command, and a delete command.

The streaming printer may output a duplex print job (double sided printing) without the use of any additional commands. The output engine may automatically print the engine-ready data in duplex mode when it detects that a page image's printable length exceeds an output medium's length.

A method for facilitating virtual cloud printing is disclosed. The method may be implemented by a cloud computing grid. The method may include receiving a print job that comprises at least one document to be printed. The method may also include dispatching printing-related tasks for the print job to one or more Software-as-a-Service (SaaS) providers in order to obtain engine-ready data. The method may also include sending the engine-ready data to a streaming printer. The method may further include sending commands to the streaming printer to control how the streaming printer processes the engine-ready data.

The print job may include a request to print a single copy of the at least one document. In this situation, the commands that are sent to the streaming printer may include a data command that causes the streaming printer to download the engine-ready data. The commands may also include an output command that causes the streaming printer to output the engine-ready data as a hardcopy and purge the engine-ready data.

The print job may include a request to print multiple copies of the at least one document. In this situation, the commands that are sent to the streaming printer may include a data command that causes the streaming printer to download the engine-ready data. The commands may also include a persist command that causes the streaming printer to store the engine-ready data in an engine cache storage. The commands may also include an output command that causes the streaming printer to output the engine-ready data.

For a first copy of the at least one document, the commands may be sent in the following sequence for each page of the at least one document: the data command, the persist command, and the output command. Second and subsequent copies of the at least one document may be printed by repetitively sending the output command. The commands that are sent to the streaming printer may further include a delete command that causes the streaming printer to delete the engine-ready data.

A computer-readable medium is disclosed. The computer-readable medium may include executable instructions for receiving a print job that comprises at least one document to be printed. The instructions may also be executable for dispatching printing-related tasks for the print job to one or more Software-as-a-Service (SaaS) providers in order to obtain engine-ready data. The instructions may also be executable for sending the engine-ready data to a streaming printer. The instructions may further be executable for sending commands to the streaming printer.

A method for printing at least one document is disclosed. The method may be implemented by a streaming printer. The method may include receiving engine-ready data corresponding to the at least one document from a cloud computing grid. The method may also include receiving commands from the cloud computing grid. The method may also include processing the engine-ready data in accordance with the commands that are received.

The exemplary operating environment for the present disclosure includes a printer or Multi-Function Printer (MFP) connected to the Internet. The MFP may receive print data in some form from the Internet, which it then subsequently processes and outputs.

Additionally, a user or process from a computing device (e.g., PC, laptop, mobile phone, or Internet appliance) can submit a print job to the Internet, which is subsequently printed on the aforementioned printer. One or more processes hosted on the Internet may provide services relating to the print job, such as discovering, queuing, format conversion, despooling or payment.

In the present disclosure, a low-cost streaming (e.g., A4 laser) printer is disclosed. This printer may include minimal electromechanical components and virtually no firmware. But, when the printer is connected to an Internet computing grid, the streaming printer can be operated in a way to appear at or near the performance, output and quality of a high-priced laser printer.

The printer may operate using a reduced command set. For outputting, the command set may consist of only four commands (e.g., data, persist, output, delete). Like an inkjet printer, input to the printer may be in engine-ready data format. Processing of the input to output is very minimal that no central processing unit (CPU) is needed. Alternatively, a very low-cost CPU may be utilized.

To print using the streaming printer, a user may submit a document and job ticket to the cloud computing grid. The cloud computing grid may perform many of the functions that otherwise would have been performed by the user's personal computer (PC), print server and/or embedded firmware. Optimally, the cloud computing grid produces engine-ready data specific to the streaming printer.

In one mode, a single copy of the document is printed. In this mode, the streaming printer can output the single copy through a two command step: (1) data (download the engine-ready data), and (2) output (output as hardcopy and purge the downloaded data).

In a second mode, the streaming printer can output multiple copies through a four command step: (1) data (download the engine-ready data), (2) persist (save downloaded data in cache), (3) output (repeat output per copy), and (4) delete (remove data from cache).

A novel aspect of the present disclosure is the interface definition between the streaming printer and the virtualized services provided over the Internet computing grid. By reducing this interface to a set of basic commands (e.g., four commands), several benefits may be achieved.

One benefit may be that implementation and manufacturing of arbitrary streaming printers can be reliably uniform across manufacturers. Another benefit may be that reducing the interface into a set of basic commands eliminates the need for model-specific printer drivers. Also, the simplified command interface may make it possible for virtualized services to use a streaming printer.

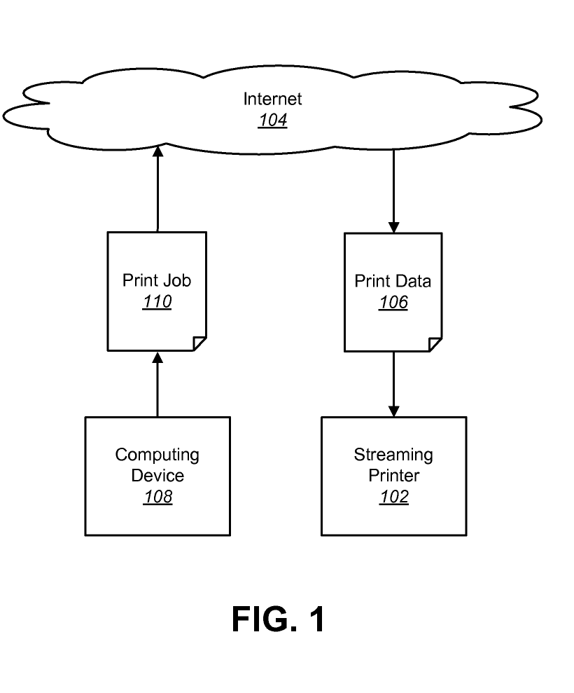

FIG. 1 illustrates an exemplary operating environment that includes one or more printers 102 which are connected to the Internet 104. The printer 102 may be an MFP. The printer 102 may be referred to herein as a streaming printer 102. The streaming printer 102 may receive print data 106 in some form from the Internet 104, which it then subsequently processes and outputs, such as hardcopy printed output.

Additionally, a user or process from a computing device 108 can submit a print job 110 to the Internet 104, which is subsequently printed on the aforementioned streaming printer 102. The user may submit the print job 110 to the Internet 104 by any means, such as file upload via a web browser, an Internet-connected printer driver, a web service print utility, email, a Short Message Service (SMS) message, a Multimedia Messaging Service (MMS) message, etc.

One or more processes hosted on the Internet 104 may provide services relating to the print job 110. Examples of print job 110 related services may include discovery, queuing/spooling, raster image processing (RIP), format translation, payment, accounting, language translation, Bates stamping, storage, page layout, device status, peripheral management, grid computing services, etc. In the later case, emulation of the execution of firmware not resident in the streaming printer 102 may be loaded and executed on a virtual platform, such as an Internet-based grid computer.

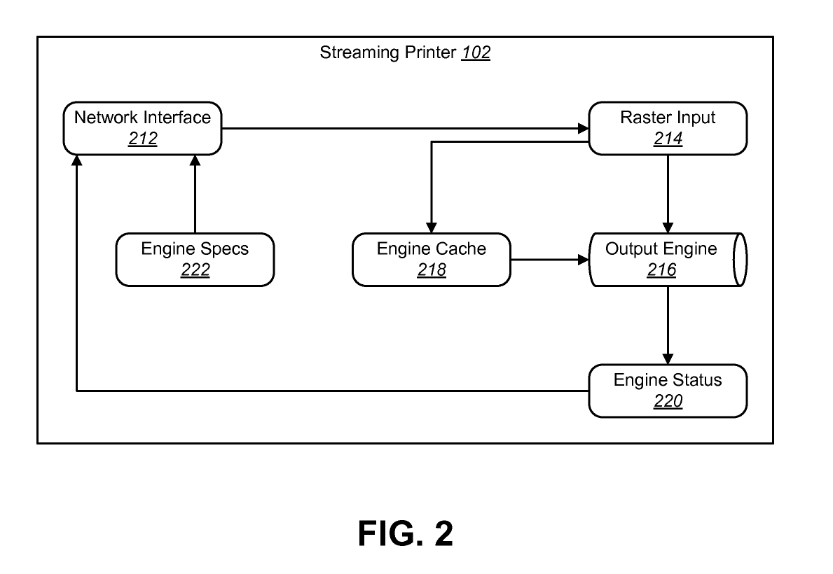

FIG. 2 illustrates the streaming printer 102. The streaming printer 102 consists of a bare-bones set of electromechanical components and firmware. Typically, the streaming printer 102 does not contain the following: a general purpose CPU, page description language (PDL) interpreters, embedded fonts, peripheral management firmware, or raster image processing (RIP) capability. Alternatively, the streaming printer 102 may include a very low-cost CPU.

The streaming printer 102 includes a network interface 212 for connecting and communicating the streaming printer 102 with the Internet 104. The network interface 212 may be implemented as hardware or firmware. The network interface 212 requires only minimal functionality such as Transmission Control Protocol/Internet Protocol (TCP/IP) addressing, Hypertext Transfer Protocol (HTTP) communication protocol, a mode for receiving raw data, etc.

The streaming printer 102 may include the following components: a raster input storage 214, an output engine 216, an engine cache 218, an engine status unit 220, and an engine specification unit 222.

The raster input storage 214 may include random access memory (RAM) that is used to temporarily hold engine-ready data for direct submission to the output engine 216 or engine cache 218. The output engine 216 may accept engine-ready page images, either from the raster input storage 214 or the engine cache 218, and output them. The engine cache 218 may persistently hold engine-ready page images. The engine status unit 220 may provide feedback on the operational status of the output engine 216 via the network interface 212. The engine specification unit 222 may provide a predetermined (hardwired) specification on the engine capabilities, such as engine speed, color space, half-toning requirements, paper size and printable area.

The raster input storage 214 may temporarily hold engine-ready data received from the network interface 21 2, until it is directed to transfer the engine-ready page data to either the output engine 216 or the engine cache 218. The raster input storage 214 can be implemented in any manner, such as RAM, flash memory, a hard drive, removable storage (e.g., a user-inserted Universal Serial Bus (USB) or flash device), grid storage (persistent storage services provided by a platform as a service), etc.

The output engine 216 may include components typical of an outputting engine in a laser printer, such as a developer and a fuser. The output engine 216 may take engine-ready page images. The engine-ready page images may be in any format directly supported by the output engine 216. For example, the engine-ready data may be 1-bit half-toned gray-scale raster bitmap, 1-bit half-toned cyan, magenta, yellow (CMY) raster bitmap, 1-bit half-toned cyan, magenta, yellow and black (CMYK) raster bitmap, etc.

The engine cache 218 can be implemented in any manner, such as those for the raster input storage 214, and where the storage mechanism may be shared with the raster input storage 214. Typically, the raster input storage 214 and engine cache 218 are coupled to the output engine 216 through a data bus. The data bus may be a wired bus on a board, a cable bus between boards, an optical bus, and so on. Additionally, the raster input storage 214 and engine cache 218 may also be connected via a data bus.

An engine status unit 220 may include one or more electromechanical sensors to determine the operational status of the output engine 216. These typically include a paper eject sensor, roller sensors for jam detection, toner level sensor, paper supply sensor, etc. Additionally, the raster input storage 214 and output engine 216 may have firmware sensors which communicate operational status, such as over a data bus, to the engine status unit 220. These might include a buffer (storage) overrun in raster input storage 214, invalid data format for output engine 216, etc.

The engine status unit 220 is communicatively coupled with the network interface 212, such as through a data bus. Changes in operational status may be asynchronously sent out the network interface 212 via a bi-directional communication link with the grid computing environment, or synchronously polled over a bidirectional communication link with the grid computing environment.

The engine specification unit 222 may provide information on the “fixed” operational characteristics of the streaming printer 102. Typically, this information is pre-stored in read-only memory (ROM) or an erasable programmable read-only memory (EPROM). The engine specification unit 222 is communicatively coupled with the network interface 212, such as through a data bus. In an alternate embodiment, the engine specification unit 222 is part of the network interface 212. For example, the engine specification 222 may be implemented via a removable ROM/EPROM chip. Engine specification information may be requested by the grid computing environment via synchronous polling. Examples of engine specification information may include maximum engine outputting speed (e.g., pages per minute), engine data color space, engine data half-toning requirements, duplex capability, paper size, printable area, serial number, model name, etc.

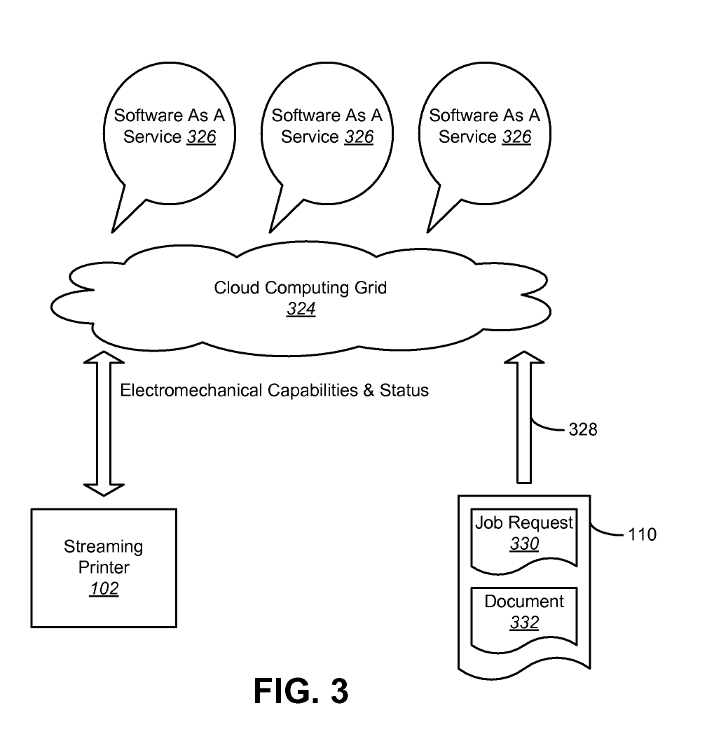

Reference is now made to FIG. 3. In another aspect of the present disclosure, the streaming printer 102 is operated from a cloud computing grid 324. A cloud computing grid 324 may be a virtualized computing platform, which may be clustered, distributed and mirrored across a variety of physical computing devices. The interface to the cloud computing grid 324 may be the Internet 104. The general management of the virtualized computing platform (also known as “platform as a service”) may be provided by a single “platform as a service” provider or an aggregation of “platform as a service” providers. Examples of “platform as a service” providers include Amazon Elastic Compute Cloud (Amazon EC2), Google App Engine, the Force.com Cloud Computing Architecture by Salesforce.com, etc.

The cloud computing grid 324 may provide one or more printing-related services 326 for the streaming printer 102. These services 326 may be provided by one or more providers, may be dynamically determined, and may be distributed across one or more “platform as a service” providers. These services 326, herein referred to as “software as a service” 326, may include print ticket submission, print queue management, filing storage, format conversion, page layout, sheet assembly, overlays, watermarks, auditing, billing, PDL interpretation, engine-specific rasterization, streaming printer discovery, streaming printer identification, peripheral (printer) management, etc.

A user may submit 328 a print job 110 to the cloud computing grid 324. Submission 328 may be accomplished by connecting to a predetermined endpoint, such as a print submission application programming interface (API) provided by a platform or Software-as-a-Service provider. An endpoint may be defined by a uniform resource locator (URL) or uniform resource identifier (URI) and defined via a web services description language (WSDL), and accessed as a web service.

The print job 110 may include a job request 330 and one or more documents 332 to print. The job request 330 may be referred to as a job ticket. The job request 330 may include information on how the document(s) are to be printed. The information may be in any suitable form, such as a Web Services for Devices (WSD) print ticket, a Microsoft XPS print ticket, or in a proprietary format. The job request 330 may include information such as the target streaming printer, the number of copies per document to print, paper size, black-and-white versus color printing, automatic versus interactive printing, filing requests, billing information, page layout, etc.

The print job 110 may be packaged in any format, such as an XPS document package, an HTTP request with Direct Internet Message Encapsulation (DIME) attachments, an FTP file transfer, etc. On receiving the print job request 330, the cloud computing grid 324 may dispatch the printing related tasks to one or more Software-as-a-Service (SaaS) providers 326.

The following is an example scenario. The print ticket 110 may be sent to a print queue service. Document(s) 332 may be sent to a temporary storage service. A format identification service may determine the application format of the document(s) 332. The document(s) 332 may be translated into a common graphics language (e.g., Graphics Device Interface (GDI), XML Paper Specification (XPS), etc.) using an application service that supports the format of the document(s) 332. The translated document(s) 332 may be sent to a temporary storage service. A PDL service, using print ticket information, may convert the translated document(s) 332 into a page description language, such as Portable Document Format (PDF), Printer Command Language (PCL), PostScript (PS), etc. A printer discovery service may obtain the engine specifications of the streaming printer 102. An RIP service may convert (i.e., rasterize) the PDL version of the document(s) 332 into engine-ready data for the streaming printer 102. A despooling service may download the engine-ready data to the streaming printer 102, and instruct it to output. A monitoring service may monitor the operational status of the streaming printer 102 during the duration of the print job. A billing service may charge the user.

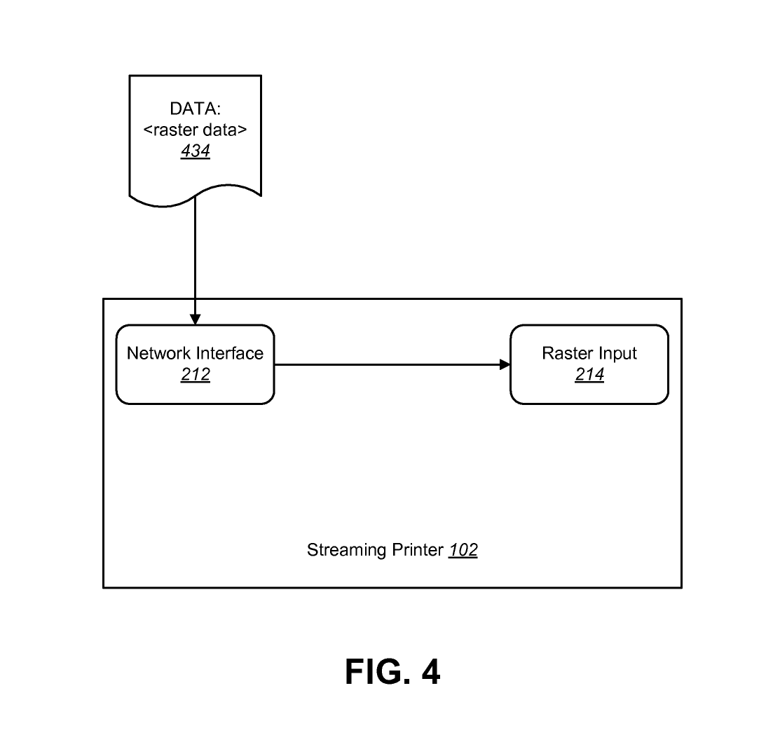

Reference is now made to FIG. 4. In another aspect of the present disclosure, the print job 110 is a request to print a single copy of one or more documents 332. The SaaS printing services 326 may prepare the print job 110. At some point, a SaaS service 326 may have produced at least one of the engine-ready page images for the streaming printer 102.

First, a SaaS 326 despooling service determines the outputting order of the pages, which may differ from the document 332 page order. The despooling service may either wait until all the engine-ready page images are available (non-streaming) or wait for the next output consecutive engine-ready page image to be available for despooling. In the later case, when the first engine-ready page image is ready, the first engine-ready page image may be despooled to the streaming printer 102 as a DATA command 434. As the engine-ready data is streamed in through the network interface 212, the engine-ready data may be temporarily stored in the raster input storage 214.

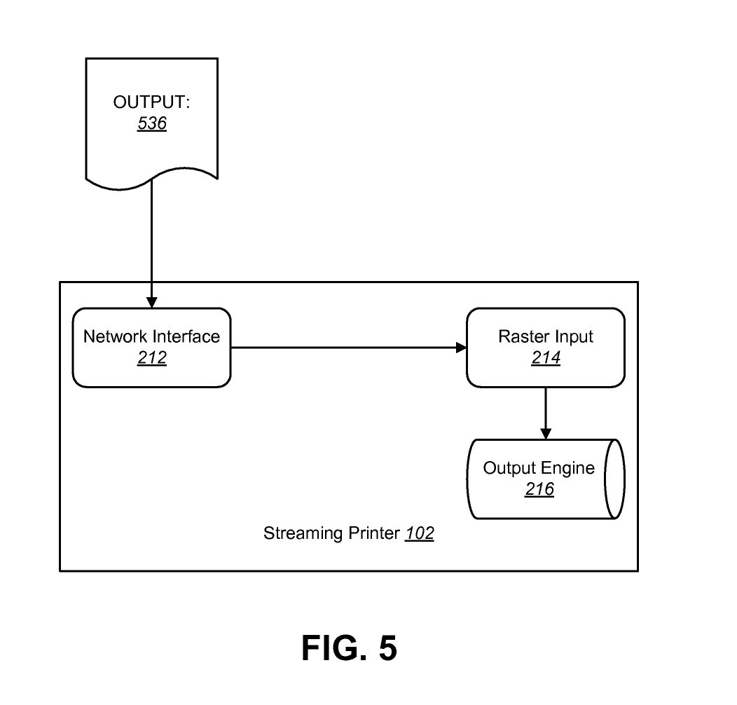

Reference is now made to FIG. 5. After despooling the engine-ready page image, the despooling service may send an OUTPUT command 536 to the streaming printer 102. The OUTPUT command 536 may cause the raster input storage 214 to transfer the engine-ready data to the output engine 216. The output engine 216 may then output (e.g., hardcopy printing) the page image. Once the page image has been outputted, the engine-ready data in the raster input storage 214 may be automatically purged.

The SaaS 236 despooling service may then consecutively despool the second, third, etc. (if any) engine-ready page images, issuing a DATA/OUTPUT command sequence 434, 536 per page image. The despooling service may receive engine-ready page images from the RIP services in non-consecutive output order and non-serially (e.g., parallel).

In another aspect of the present disclosure, the print job 110 may be a request to print multiple copies of one or more documents 332. The SaaS 326 printing services may prepare the print job 110. At some point, an SaaS 326 service may have produced at least one of the engine-ready page images for the streaming printer 102.

First, an SaaS 326 despooling service may determine the outputting order of the pages, which may differ from the document page order. The despooling service may either wait until all the engine-ready page images are available (non-streaming) or wait for the next output consecutive engine-ready page image to be available for despooling. In the later case, when the first engine-ready page image is ready, the first engine-ready page image may be despooled to the streaming printer 102 as a DATA command 434. As the engine-ready data is streamed in through the network interface 212, the engine-ready data may be temporarily stored in the raster input storage 214.

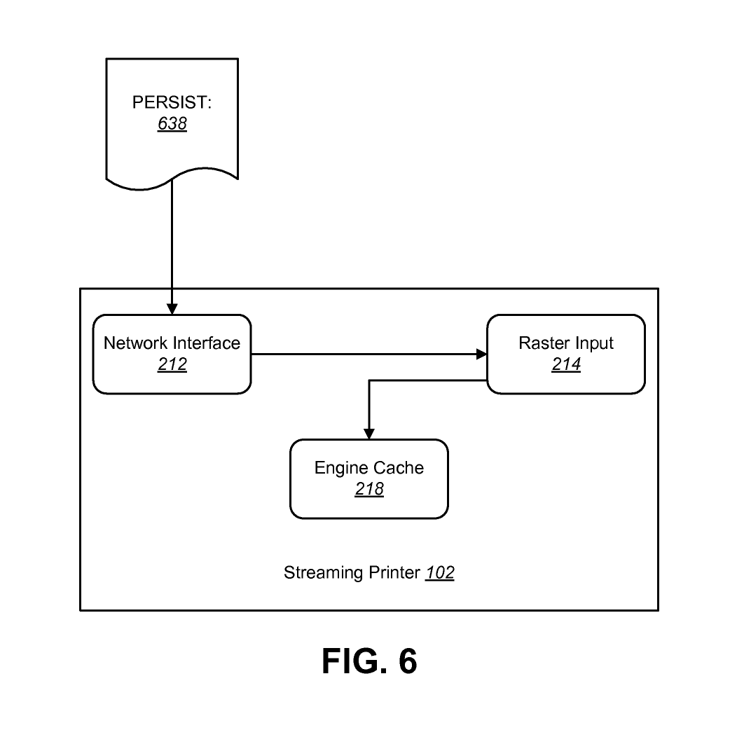

Reference is now made to FIG. 6. After despooling the engine-ready page image, the despooling service may send a PERSIST command 638 to the streaming printer 102. The PERSIST command 638 may cause the raster input storage 214 to transfer the engine-ready data to the engine cache 218. The engine-ready page image may persist in the engine cache 218 until a command is received to purge the cache.

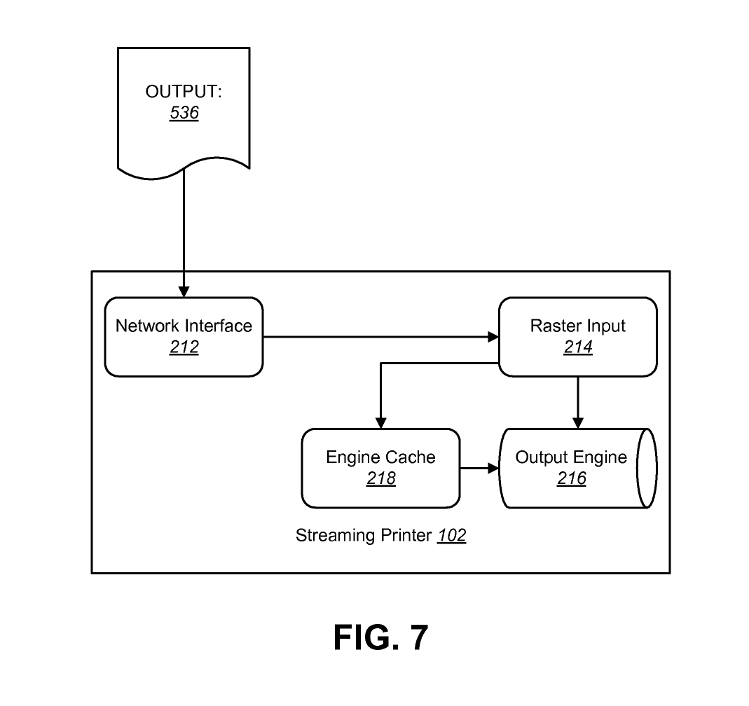

Reference is now made to FIG. 7. After sending a PERSIST command 638, the despooling service may send an OUTPUT command 536 to the streaming printer 102. In response, the streaming printer 102 may transfer a copy of the first engine-ready page image from the engine cache 218 to the output engine 216. The output engine 216 may then output (e.g., via hardcopy printing) the engine-ready page image.

The SaaS 326 despooling service may then consecutively, in output page order, send the second, third, etc. engine-ready page images, if any, to the streaming printer 102. Each page may be sent in a DATA 434, PERSIST 638, OUTPUT 536 sequence. The engine cache 218 may act as a circular queue. As long as each consecutive page is transmitted with the DATA 434, PERSIST 638 and OUTPUT 536 sequence on the first copy, the latest page loaded into the engine cache 218 (PERSIST 638) will be the next page outputted (OUTPUT 536).

Once the SaaS 326 despooling service determines that the last page of the first copy has been outputted by the output engine 216, the service may start sending commands to the streaming printer 102 to start outputting the second and subsequent copies. Since no new data will be downloaded (DATA command 434) to the streaming printer 102, the engine-ready page image queue in the engine cache 218 may circle around, with the first outputting page of the print job 110 to be the next page to be transferred from the engine cache 218. The SaaS 326 despooling service may then repetitively send an OUTPUT command 536, one per output page in the print job 110 (i.e., second copy). This step may then be repeated for each additional copy in the print job 110.

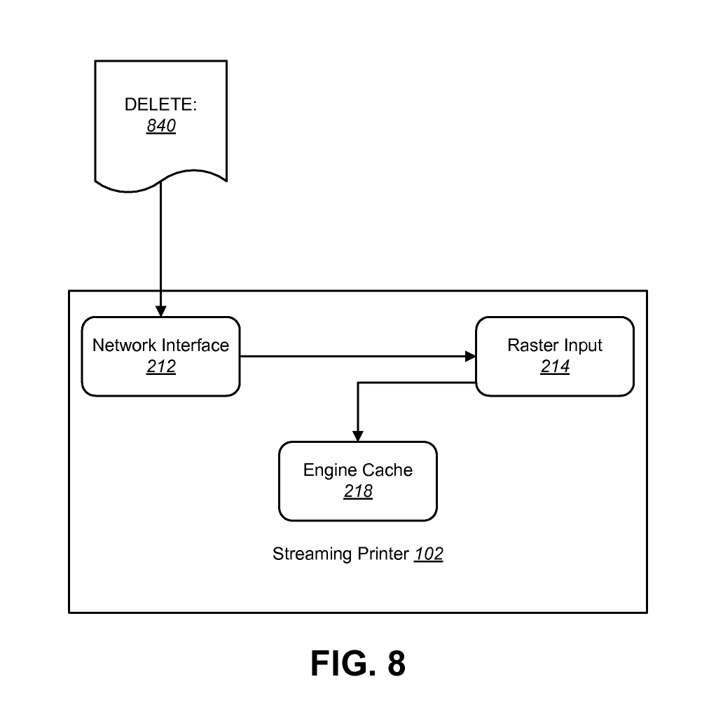

Reference is now made to FIG. 8. Once all copies have been outputted, the SaaS 326 despooling service may send a DELETE command 840 to the streaming printer 102. The DELETE command 840 may cause the streaming printer 102 to purge all persisted engine-ready page images in the engine cache 218.

Another aspect of the present disclosure relates to outputting a duplex print job 110 (double sided printing) without the use of any additional commands. The printable length of an engine-ready page image may exceed the length of the output medium (e.g., paper sheet). When this condition is detected by the output engine 216, the output engine 216 may automatically print the engine-ready page image in duplex mode. That is, the engine-ready data up to the threshold of the printable length of the output medium may be printed on a first side of the output medium. The engine-ready data exceeding the threshold may then be printed on a second side of the output medium.

The SaaS 326 page layout service can also control whether the duplex printing is done in book or tablet mode by setting the orientation of the engine-ready data that exceeds the threshold (i.e., second page image). For example, in a paper reversing duplex feeder, a book order duplex print may be achieved by placing the second page image in the reverse (180 degrees) orientation of the first page image, and tablet order duplex print may be achieved by placing the second page image in the same orientation of the first page image.

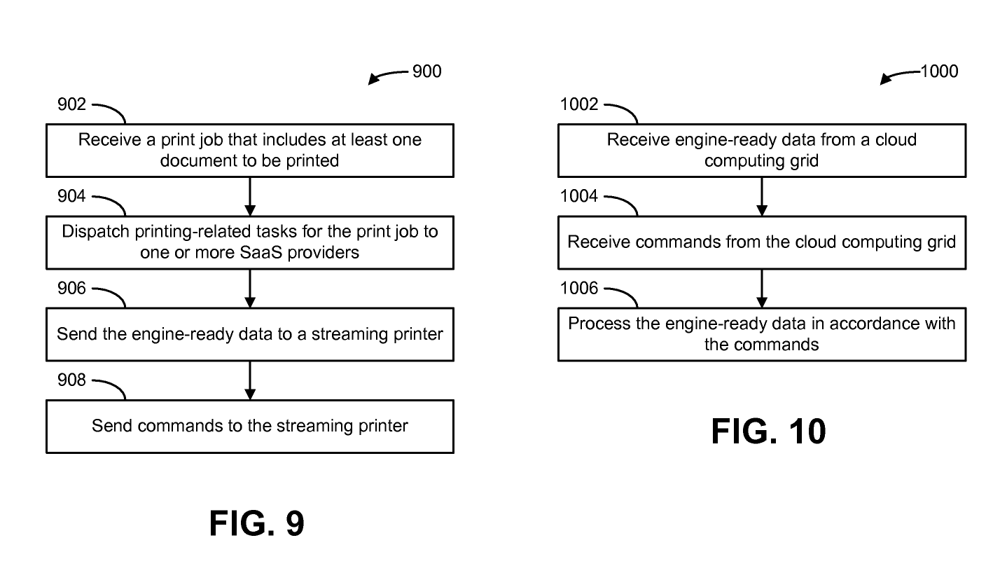

FIG. 9 illustrates a method 900 for facilitating virtual cloud printing. The method 900 may be implemented by a cloud computing grid 324. The cloud computing grid 324 may receive 902 a print job 110 that includes at least one document 332 to be printed. The cloud computing grid 324 may dispatch 904 printing-related tasks for the print job 110 to one or more SaaS providers 326 in order to obtain engine-ready data. The cloud computing grid 324 may send 906 the engine-ready data to a streaming printer 102. The cloud computing grid 324 may also send 908 commands (e.g., data 434, persist 638, output 536, delete 840) to the streaming printer 102 to control how the streaming printer 102 processes the engine-ready data.

FIG. 10 illustrates a method 1000 for printing at least one document 332. The method 1000 may be implemented by a streaming printer 102. The streaming printer 102 may receive 1002 engine-ready data corresponding to the document(s) 332 to be printed. The engine-ready data may be received 1002 from a cloud computing grid 324. The streaming printer 102 may also receive 1004 commands (e.g., data 434, persist 638, output 536, delete 840) from the cloud computing grid 324. The streaming printer 102 may process the engine-ready data in accordance with the commands that are received.

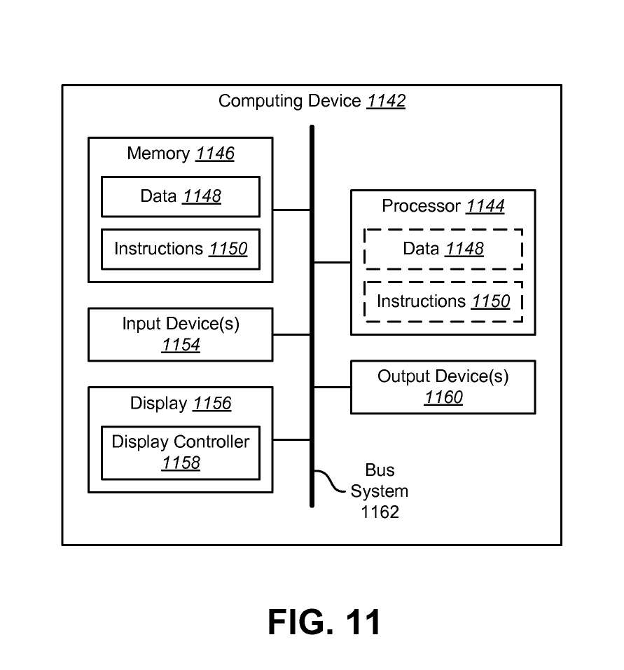

Reference is now made to FIG. 11. FIG. 11 illustrates certain components that may be included within a computing device 1142. A computing device 1142 may be used to submit a print job 110 to the cloud computing grid 324. Also, the cloud computing grid 324 may be implemented with one or more computing devices 1142.

The computing device 1142 includes a processor 1144. The processor 1144 may be a general purpose single- or multi-chip microprocessor (e.g., an ARM), a special purpose microprocessor (e.g., a digital signal processor (DSP)), a microcontroller, a programmable gate array, etc. The processor 1144 may be referred to as a central processing unit (CPU). Although just a single processor 1144 is shown in the computing device 1142 of FIG. 11, in an alternative configuration, a combination of processors (e.g., an ARM and DSP) could be used.

The computing device 1142 also includes memory 1146. The memory 1146 may be any electronic component capable of storing electronic information. The memory 1146 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 1148 and instructions 1150 may be stored in the memory 1146. The instructions 1150 may be executable by the processor 1144 to implement methods disclosed herein. Executing the instructions 1150 may involve the use of the data 1148 that is stored in the memory 1146.

The computing device 1142 may also include one or more communication interfaces 1152 for communicating with other computing devices. Communication with other computing devices may occur directly and/or via a computer network. A communication interface 1152 may include one or more communication ports, such as Ethernet ports, Universal Serial Bus (USB) ports, parallel ports, serial ports, etc.

The computing device 1142 may also include one or more input devices 1154. Examples of input devices 1154 include a keyboard, mouse, remote control device, microphone, button, joystick, trackball, touchpad, lightpen, etc.

The computing device 1142 may also include a display 1156. A display controller 1158 may also be provided, for converting data 1148 stored in the memory 1146 into text, graphics, and/or moving images (as appropriate) shown on the display 1156. One or more other output devices 1160, such as audio speakers, may also be included in the computing device 1142.

The various components of the computing device 1142 may be coupled together by one or more buses, which may include a power bus, a control signal bus, a status signal bus, a data bus, etc. For the sake of clarity, the various buses are illustrated in FIG. 11 as a bus system 1162.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A streaming printer that facilitates virtual cloud printing, comprising:
a network interface that receives engine-ready data from a cloud computing grid;
a raster input storage that temporarily holds the engine-ready data that is received via the network interface;
an engine cache storage that persistently holds the engine-ready data; and
an output engine that outputs the engine-ready data.

2. The streaming printer of claim 1, wherein the streaming printer does not include a general purpose central processing unit (CPU).

3. The streaming printer of claim 2, wherein the streaming printer also does not include page description language (PDL) interpreters, embedded fonts, peripheral management firmware, or raster image processing (RIP) capability.

4. The streaming printer of claim 1, further comprising an engine status unit that provides feedback on the operational status of the output engine.

5. The streaming printer of claim 1, further comprising an engine specification unit that provides information about operational characteristics of the streaming printer.

6. The streaming printer of claim 1, wherein the streaming printer operates using a reduced command set that consists of a data command, a persist command, an output command, and a delete command.

7. The streaming printer of claim 1, wherein the output engine automatically prints the engine-ready data in duplex mode when it detects that a page image's printable length exceeds an output medium's length.

8. A method for facilitating virtual cloud printing, the method being implemented by a cloud computing grid, the method comprising:
receiving a print job that comprises at least one document to be printed;
dispatching printing-related tasks for the print job to one or more Software-as-a-Service (SaaS) providers in order to obtain engine-ready data;
sending the engine-ready data to a streaming printer; and
sending commands to the streaming printer to control how the streaming printer processes the engine-ready data.

9. The method of claim 8, wherein the print job comprises a request to print a single copy of the at least one document, and wherein the commands comprise:
a data command that causes the streaming printer to download the engine-ready data; and
an output command that causes the streaming printer to output the engine-ready data as a hardcopy and purge the engine-ready data.

10. The method of claim 8, wherein the print job comprises a request to print multiple copies of the at least one document, and wherein the commands comprise:
a data command that causes the streaming printer to download the engine-ready data;
a persist command that causes the streaming printer to store the engine-ready data in an engine cache storage; and
an output command that causes the streaming printer to output the engine-ready data.

11. The method of claim 10, wherein for a first copy of the at least one document, the commands are sent in the following sequence for each page of the at least one document:
the data command,
the persist command, and
the output command.

12. The method of claim 10, wherein second and subsequent copies of the at least one document are printed by repetitively sending the output command.

13. The method of claim 10, wherein the commands further comprise a delete command that causes the streaming printer to delete the engine-ready data.

14. A computer-readable medium comprising executable instructions for:
receiving a print job that comprises at least one document to be printed;
dispatching printing-related tasks for the print job to one or more Software-as-a-Service (SaaS) providers in order to obtain engine-ready data;
sending the engine-ready data to a streaming printer; and
sending commands to the streaming printer.

15. A method for printing at least one document, the method being implemented by a streaming printer, the method comprising:
receiving engine-ready data corresponding to the at least one document from a cloud computing grid;
receiving commands from the cloud computing grid; and
processing the engine-ready data in accordance with the commands that are received.

16. The method of claim 15, wherein a single copy of the at least one document is printed, and wherein the commands comprise:
a data command that causes the streaming printer to download the engine-ready data; and
an output command that causes the streaming printer to output the engine-ready data as a hardcopy and purge the engine-ready data.

17. The method of claim 15, wherein multiple copies of the at least one document are printed, and wherein the commands comprise:
a data command that causes the streaming printer to download the engine-ready data;
a persist command that causes the streaming printer to store the engine-ready data in an engine cache storage; and
an output command that causes the streaming printer to output the engine-ready data.

18. The method of claim 17, wherein for a first copy of the at least one document, the commands are received in the following sequence for each page of the at least one document:
the data command,
the persist command, and
the output command.

19. The method of claim 17, wherein the output command is repetitively received in order to print second and subsequent copies of the at least one document.

20. The method of claim 17, wherein the commands further comprise a delete command that causes the streaming printer to delete the engine-ready data.
